(19) United States
(12) Patent Application Publication
(10) Pub. No.: US 2025/0009160 A1
(43) Pub. Date: Jan. 9, 2025

(54) BATTERY POWERED SLOW COOKER ASSEMBLY

(71) Applicant: Karen Bright, Norfolk, NE (US)

(72) Inventor: Karen Bright, Norfolk, NE (US)

(21) Appl. No.: 18/219,050

(22) Filed: Jul. 6, 2023

(51) Int. Cl. A47J 27/00

(52) U.S. Cl. CPC A47J 27/002; A47J 27/004

(57) ABSTRACT

A battery powered slow cooker assembly for allowing continued heating of food when the slower cooker is not plugged into an electric outlet includes a housing defining a cooking space containing a food item therein. A heat emitter is coupled to the housing and emits heat into the cooking space when turned on. A power supply is electrically couplable to the heat emitter. The power supply includes a power port receiving a power cord plugged into an electrical outlet and a rechargeable battery mounted in the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to slow cookers and more particularly pertains to a new slow cooker that utilizes an auxiliary battery to allow for continued powering of the slow cooker being unplugged from an electrical outlet.

### (2) Description of Related Art Including Information Disclosed Under 37 CFR 1.97 and 1.98

The prior art relates to slow cookers and teaches a variety of slow cookers having a power supply including a rechargeable battery. Known prior art does not teach a slow cooker having a power supply include a power cord and a rechargeable battery such that the slow cooker can be utilized when unplugged from an electric outlet.

### BRIEF SUMMARY OF THE INVENTION

An embodiment of the disclosure meets the needs presented above by generally comprising a housing defining a cooking space configured to contain a food item therein. A heat emitter is coupled to the housing and emits heat into the cooking space when turned on. A power supply is electrically couplable to the heat emitter. The power supply includes a power port receiving a power cord configured to be plugged into an electrical outlet and a rechargeable battery mounted in the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a battery powered slow cooker assembly according to an embodiment of the disclosure.

FIG. 2 is a detail isometric view of an embodiment of the disclosure take from area “2” of FIG. 1.

FIG. 3 is a bottom isometric view of an embodiment of the disclosure.

FIG. 4 is a front view of an embodiment of the disclosure.

FIG. 5 is a side view of an embodiment of the disclosure.

FIG. 6 is an in-use view of an embodiment of the disclosure.

### DETAILED DESCRIPTION OF THE INVENTION

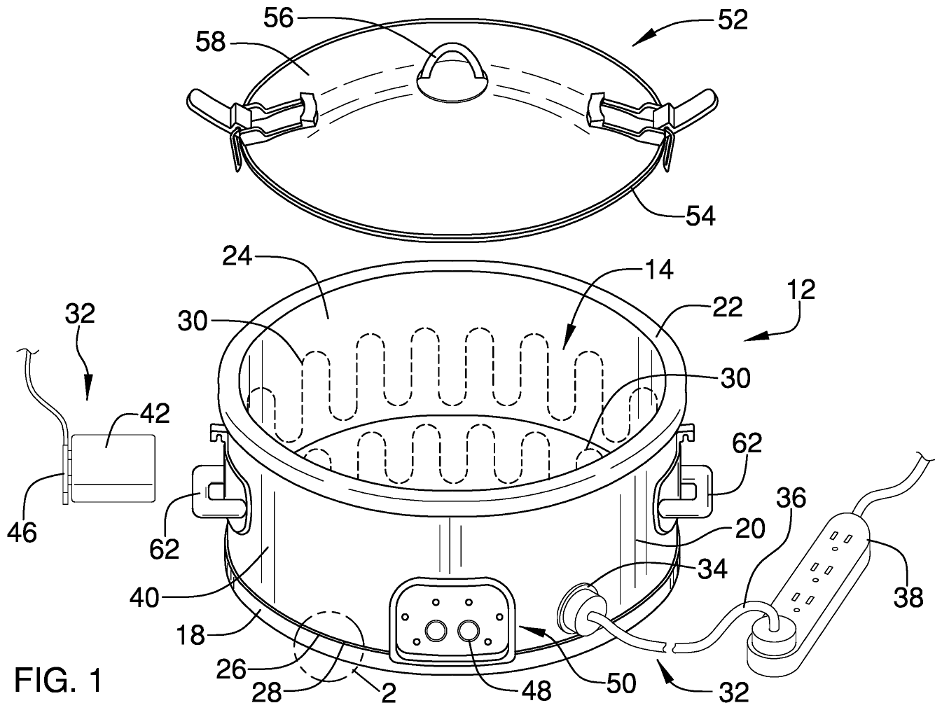

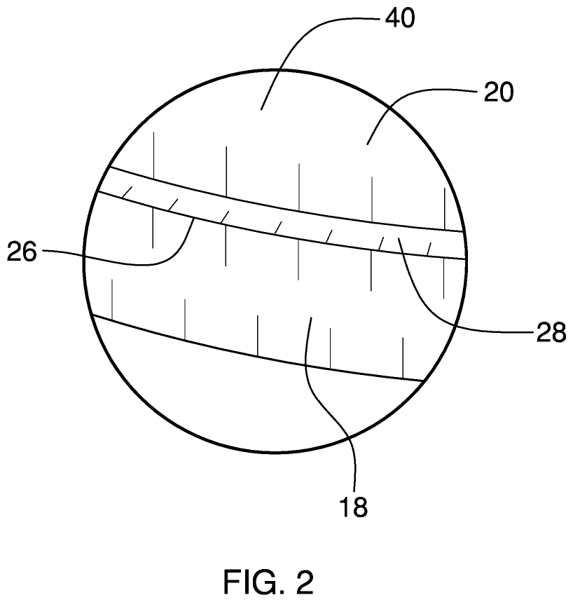

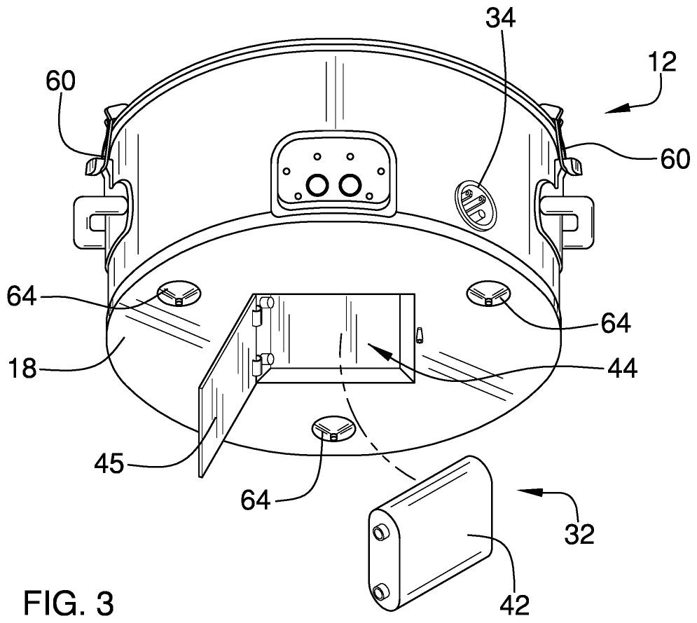

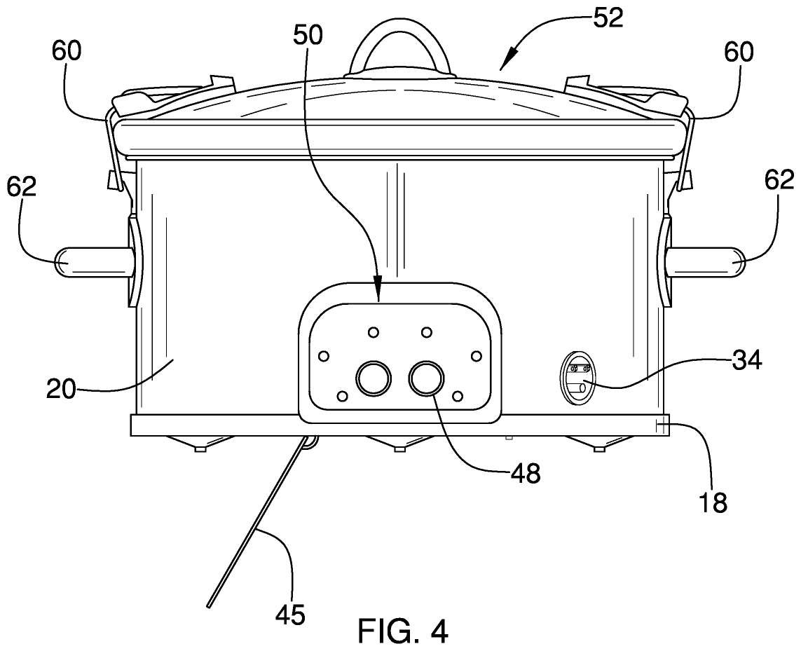

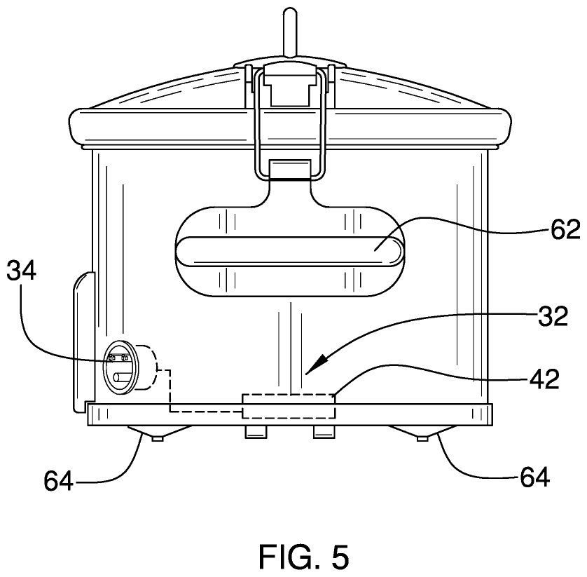

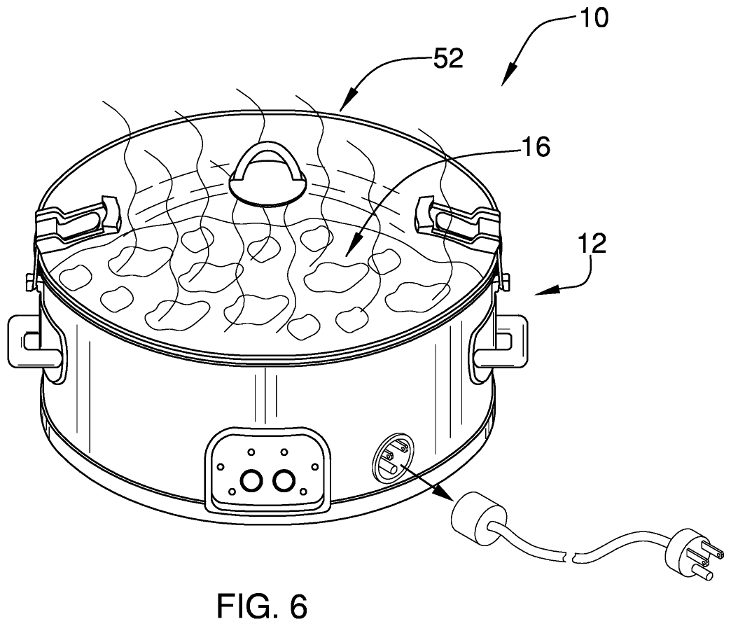

With reference now to the drawings, and in particular to FIGS. 1 through 6 thereof, a new slow cooker embodying the principles and concepts of an embodiment of the disclosure and generally designated by the reference numeral 10 will be described.

As best illustrated in FIGS. 1 through 6, the battery powered slow cooker Assembly 10 generally comprises a housing 12 defining a cooking space 14 configured to contain a food item 16 therein. The housing 12 includes a base wall 18 and a perimeter wall 20 coupled to and extending upwardly from the base wall 18. An upper edge 22 of the perimeter wall 20 defines an opening into the cooking space 14. An interior surface 24 of the perimeter wall 20 typically comprises a conductive material such as metal, ceramic, or any other conductive material conventionally used by slow cookers. An outer edge 26 of an upper surface 28 of the base wall 18 has a continuously concavely arcuate shape. A heat emitter 30 is coupled to the housing 12 and emits heat into the cooking space 14 when turned on. The heat emitter 30 comprises a plurality of heating coils positioned within the perimeter wall 20 and the base wall 18.

A power supply 32 is electrically couplable to the heat emitter 30. The power supply 32 includes a power port 34 receiving a power cord 36 configured to be plugged into an electrical outlet 38. The power port 34 is positioned on an exterior surface 40 of the perimeter wall 20. The power port 34 typically comprises a three-prong plug positioned within a cavity extending into the exterior surface 40 of the perimeter wall 20, wherein the power cord 36 includes an electrical receptacle being insertable into the cavity to receive the three-prong plug.

The power supply 32 also includes a rechargeable battery 42 mounted in the housing 12. The rechargeable battery 42 is removably positioned in a compartment 44 extending into the base wall 18. A door 45 is hingedly attached to the base wall 18 and is pivotally positionable to enclose the compartment 44. The rechargeable battery 42 is removed from the housing 12 to receive power from a battery charger 46. The rechargeable battery 42 is inserted into the compartment 44 to provide power to the heat emitter 30 when the power cord 36 is not coupled into the power port 34, wherein the heat emitter 30 continues to cook the food item 16 within the cooking space 14 when the power supply 32 cannot receive power from the power port 34.

A switch 48 is electrically coupled to the heat emitter 30, the switch 48 is actuated to turn on or off the heat emitter 30. The switch 48 is mounted on the exterior surface 40 of the perimeter wall 20. The switch 48 typically includes a plurality of control buttons 50 being actuated to manipulate a temperature of heat emitted from the heat emitter 30. The plurality of control buttons 50 may be actuated to set a timer for cooking the food item 16 within the cooking space 14.

A lid 52 is removably mounted to the upper edge 22 of the perimeter wall 20 to close the opening of the cooking space 14. The lid 52 comprises a panel 54 and a handle 56 is attached to a top surface 58 of the panel 54. The top surface 58 of the panel 54 typically is convexly arcuate. The panel 54 normally is transparent such that a person may view within the cooking space 14 when the lid 52 is mounted to the housing 12. A fastener 60 releasably fastens the housing 12 and to the lid 52. The fastener 60 typically comprises a toggle latch including a pair of extendable arm members attached to the exterior surface 40 of the perimeter wall 20 and a pair of latch plate members attached to the top surface 58 of the panel 54, wherein each of the extendable arm members releasably secures to a respective one of the pair of latch plates. In another embodiment, the fastener 60 may comprise a magnet attached to a boundary edge of the panel 54 such that the lid 52 magnetically engages with the upper edge 22 of the perimeter wall 20 when the perimeter wall 20 comprises a ferrous material.

A pair of grips 62 is coupled to the housing 12. Each of the grips 62 is mounted to the exterior surface 40 of the perimeter wall 20. Each of the grips 62 is positioned on a respective one of a pair of lateral sides of the housing 12 such that the grips 62 are configured to balance the housing 12 in an upright position when the housing 12 is carried by a person such that the food item 16 does not spill out through the opening of the cooking space 14. A plurality of feet 64 is mounted to and extending downwardly from the base wall 18. The feet 64 hold the base wall 18 off from the surface the housing 12 is positioned upon.

In use, the power port 34 receives the power cord 36, and the power cord 36 is plugged into the electrical outlet 38. The cooking space 14 receives the food item 16, and the switch 48 is actuated to turn on the heat emitter 30 such that the food item 16 begins to cook within the cooking space 14. The power cord 36 is removed from the power port 34, and the rechargeable battery 42 is inserted into the compartment 44 to provide power to the heat emitter 30 such that the housing 12 may portably heat the food item 16 within the cooking space 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food cooking and warming assembly comprising:
a housing defining a cooking space configured to contain a food item therein;
a heat emitter being coupled to said housing and emitting heat into said cooking space when turned on;
a power supply being electrically couplable to said heat emitter, said power supply including:
a power port receiving a power cord configured to be plugged into an electrical outlet; and
a rechargeable battery mounted in said housing.

2. The food cooking and warming assembly of claim 1, wherein said housing includes a base wall and a perimeter wall coupled to and extending upwardly from said base wall, an upper edge of said perimeter wall defining an opening into said cooking space, an outer edge of an upper surface of said base wall having a continuously concavely arcuate shape.

3. The food cooking and warming assembly of claim 2, wherein said heat emitter comprises a plurality of heating coils positioned within said perimeter wall and said base wall.

4. The food cooking and warming assembly of claim 2, wherein said power port is positioned on an exterior surface of said perimeter wall.

5. The food cooking and warming assembly of claim 2, wherein said rechargeable battery is removably positioned in a compartment extending into said base wall.

6. The food cooking and warming assembly of claim 2, further including a switch being electrically coupled to said heat emitter, said switch being actuated to turn on or off said heat emitter, said switch being mounted on said exterior surface of said perimeter wall.

7. The food cooking and warming assembly of claim 2, further including a lid being removably mounted to said upper edge of said perimeter wall to close said opening of said cooking space, said lid comprising a panel and a handle being attached to a top surface of said panel.

8. The food cooking and warming assembly of claim 7, further including a fastener releasably fastening said housing and to said lid.

9. The food cooking and warming assembly of claim 2, further including a pair of grips being coupled to said housing, each of said grips being mounted to said exterior surface of said perimeter wall.

10. The food cooking and warming assembly of claim 2, further including a plurality of feet being mounted to and extending downwardly from said base wall.

11. A food cooking and warming assembly comprising:
a housing defining a cooking space configured to contain a food item therein, said housing including a base wall and a perimeter wall coupled to and extending upwardly from said base wall, an upper edge of said perimeter wall defining an opening into said cooking space, an outer edge of an upper surface of said base wall having a continuously concavely arcuate shape;
a heat emitter being coupled to said housing and emitting heat into said cooking space when turned on, said heat emitter comprising a plurality of heating coils positioned within said perimeter wall and said base wall;
a power supply being electrically couplable to said heat emitter, said power supply including:
a power port receiving a power cord configured to be plugged into an electrical outlet, said power port being positioned on an exterior surface of said perimeter wall; and
a rechargeable battery mounted in said housing, said rechargeable battery being removably positioned in a compartment extending into said base wall;
a switch being electrically coupled to said heat emitter, said switch being actuated to turn on or off said heat emitter, said switch being mounted on said exterior surface of said perimeter wall;
a lid being removably mounted to said upper edge of said perimeter wall to close said opening of said cooking space, said lid comprising a panel and a handle being attached to a top surface of said panel;
a fastener releasably fastening said housing and to said lid;
a pair of grips being coupled to said housing, each of said grips being mounted to said exterior surface of said perimeter wall; and
a plurality of feet being mounted to and extending downwardly from said base wall.
